(19) United States
(12) Patent Application Publication
(10) Pub. No.: US 2002/0192007 A1
(43) Pub. Date: Dec. 19, 2002

(54) Retractable ink pen

(76) Inventor: Rocky Jenlon Lee, Cerritos, CA (US)

Correspondence Address: Rocky Jenlon Lee, 15F NO. 20, Lane 145 Zhang Shu 1 Road, Shichih Taipei, 221, TW

(21) Appl. No.: 09/853,984

(22) Filed: May 11, 2001

(51) Int. Cl. B43K 24/02; B43K 7/12; B43K 5/16

(52) U.S. Cl. 401/117; 401/99

(57) ABSTRACT

All tip retractable pens have no caps to cover their pen tips, instead their pen tips or tip protection covers are retractable such as mechanical ball pens, twisted ball pens or telescopic ball pens. Theirs pen tips will be same direction to theirs clips, and always point to ground either in writing or any time unused. Because theirs structure as retractable pen, they don't need caps. To make retractable pen be able to use liquid ink, this invention use spool valves inside the liquid ink cartridge, which also applies on the pen tip is same direction with its pen clip or has no cap to cover its pen tip. Using an air valve, a pen tip valve, a valve rod, and a pushing or twist action to change valves result as unused state: the pen tip valve close ink path and the air valve opens to vent expansion air. And as writing state: the air valve closed to create a vacuum to hold ink in tube and the pen tip valve open the ink to pen tips and air vents through an outlet at top of valve rod to balance pressure.

### BACKGROUND OF INVENTION

1. Field of the Invention

This invention relates to a retractable ball pen in water base liquid ink. All tip retractable pens have no caps to cover their pen tips, instead their pen tips or tip protection covers are retractable such as mechanical ball pens, twisted ball pens or telescopic ball pens. Theirs pen tips will be same direction to theirs clips, and always point to ground either in writing or any time unused. Because theirs structure as retractable pen, they don't need caps. They all are limited by oil type ink, and can not apply to water base ink. A water base ink ball pen needs a vacuum to hold the ink when writing, so the air orifice must locate at bottom to create the vacuum at top. Because low viscosity ink naturally stays at bottom by gravity and if air at top expending, the ink will expel out first unless reverse the pen body. Normally a liquid ink pen needs to reverse pen body to let air stays at top to balance pressure when unused or needs a cap to seal pen tip to prevent ink dripping on pen tip. Although there are lots of mechanical retract ball pens and twist ball pens in the market, but all are oil type ink or gel type ink only, because water liquid ink in that kind of structure will drip ink if temperature or atmosphere been changed.

2. Brief Description of the Prior Art

The application Ser. No. 09/573474 use labyrinth groove bar to store expansion ink. It has many thin walls and tiny gaps at outside of the pen tip valve, plus some precision holes at inside of the valve, this needs a precision mold which cost will be high.

### SUMMARY OF THE INVENTION

An object of this invention is to simply the structure of previous invention U.S. patent application Ser. No. 09/573474 Ink Ball Pen. Use hollow valve rod to store expansion ink and centralize exhaust air. This improvement simpler the structure than previous to perform same result that is: To make them no need to reverse pen body as their structure limited, using its pen tip in and out action to control valves to reduce pressure and change exhaust air direction to avoid contaminates clothes

### BRIEF DESCRIPTION OF DRAWING

FIG. 1 shows ink pen cartridge that pen tip valve with one-valve type at writing state.

FIG. 2 shows ink pen cartridge that pen tip valve with one-valve type between changing states.

FIG. 3 shows ink pen cartridge that pen tip valve with one-valve type at unused state

FIG. 4 shows ink pen cartridge that pen tip valve with two-valve type at writing state.

FIG. 5 shows ink pen cartridge that pen tip valve with two-valve type between changing state.

FIG. 6 shows ink pen cartridge that pen tip valve with two-valve type at unused state.

FIG. 7 shows the pen tip valve has no vent valve with a duct outside of valve rod in writing state.

FIG. 8 shows ink cartridge in two-chamber and pen tip valve with one-valve type at writing state.

FIG. 9 shows ink cartridge in two-chamber and pen tip valve with two-valve type and the vent duct direct to reservoir at unused state.

FIG. 10 shows a magnify drawing of labyrinth groove bar which locate at inside of the valve rod.

FIG. 11 shows a magnify drawing of steal ball check which at below the outlet of the valve rod.

FIG. 12 shows ink pen cartridge in a mechanical ball pen at writing state.

FIG. 13 shows directly applied on pen body in a push type ball pen at unused state.

FIG. 14 shows ink pen cartridge in a twist ball pen at writing state.

FIG. 15 shows directly applied in a twist ball pen and the air spool sealed at unused state.

FIG. 16 shows one valve in pen tip cartridge in a telescopic ball pen at writing state.

FIG. 17 shows one valve in pen tip cartridge in a telescopic ball pen at unused state.

### DETAL DESCRIPTION OF THE INVENTION

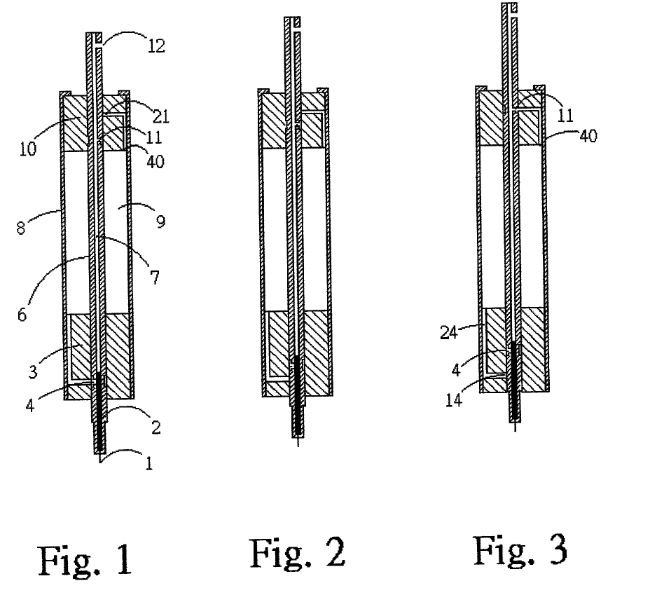

Refer to FIG. 1, which is a cut section of this invention in an ink refill or cartridge. When empty this cartridge is replaceable at inside of a pen stick or pen body 36. The pen body 36 in this invention is a retractable pen body with a retractable spring to retract its tip if needed. This type pen has no cap to protect its pen tip, instead its pen tip, or its pen tip protection cover is retractable. It may use same structure inside of the cartridge tube 8 direct to inside of the pen body 36 without the cartridge tube 8. This cartridge comprises a cartridge tube8, a spool valve type air valve body 10 at top of inner cartridge tube8, a spool valve type pen tip valve body 3 at bottom of inner cartridge tube8, a valve rod 6 at inside center of cartridge tube. The ink is stored in ink reservoir 9, which is the space between the air valve body 10, and the pen tip valve body 3 excludes the valve rod 6.

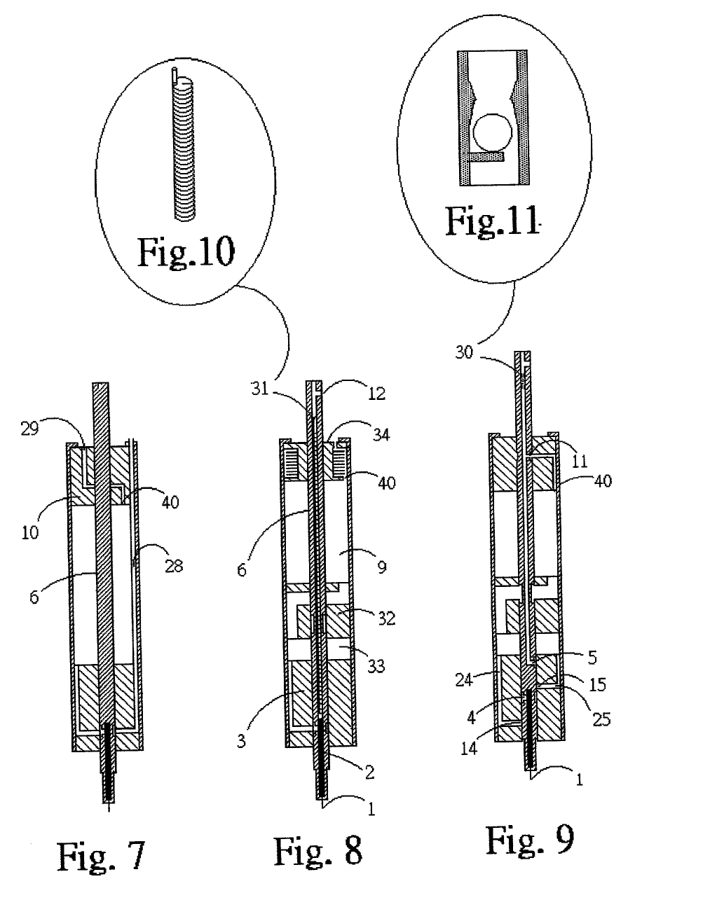

The air valve body 10 contains a reservoir vent 40 to balance ink reservoir 9 with outside by an outlet 29 on the valve body 10 as FIG. 7 shows or by an opening inside the valve rod as FIG. 3 shows. The pen tip valve body 3 contains an ink orifice 14 and ink duct 24 as FIG. 3 shows. The valve rod 6, outside with some smaller diameter sections become spools as an air spool 11 matches the air orifice 21, an ink spool 4 matches the ink orifice 14. And a pen tip 1 at bottom end of the valve rod 6. Inside of the valve rod 6 has a hollow duct 7 that provides connection among an air outlet 12 at top end, the air spool 11 and pass the absorbing material 2 to the ink spool 4. The pen tip 1 inside contains ink-absorbing material 2, such as felt, to draw ink to the pen tip 1. The pen tip may includes a ballpoint pen tip, a marker pen tip, fountain pen tip or any type of water base ink pen tip which will not dry easily. Because changing the alignment of a spool toward its valve body orifice will change the open and close of that valve. Therefor, The air valve consists of the air spool 11 on the valve rod 6 and the air orifice 21 at the air valve body 10. The ink valve consists of the ink spool 4 on the valve rod 6 and the ink orifice 14 in the pen tip valve body 3. The pen tip valve contains the ink valve.

When push a tip retractable pen to overcome its retract spring 13, the pen tip extend out for writing. At same time, this action moves the valve rod 6 to change its relative position with all valve bodies. The air spool 11 will change state from aligned to not align toward the air orifice 21 while the ink spool 4 still at closed state as FIG. 2 shows. Because in a sealed space and the valve rod and valve spools moving-in volume is the same as moving-out volume, there will be no pressure difference at the pen tip 1 and ink reservoir 9 during spools moving. So there will be no leak during changing valves states. After the air spool 11 closed, the ink spool 4 will change state from not aligned to aligned and opens the connection between ink reservoir 9, and the pen tip 1 as FIG. 1 shows a writing state. Then the pen tip absorbing material 2 has started to draw the ink from ink reservoir 9. Due to the air orifice 21 at top is sealed and some ink has been drawn, a vacuum is created inside of ink reservoir 9. Later when this vacuum is strong enough, the air from the air outlet 12 will pass through the absorbing material 2, the ink spool 4 and the ink duct 24 into ink reservoir 9 to balance the vacuum pressure. Due to ink gravity in absorbing material 2 and capillary action when the pen tip 1 touches a paper cause to generate a force to keep drawing ink to the paper during continue writing.

When another action to move tip retract in a tip retractable pen, it will move the valve rod 6 position to change all valves states. The ink spool 4 will change state from open to close toward the ink orifice 14 and break connection between ink reservoir 9 and the pen tip 1 while the air spool 11 still in close condition as FIG. 2 shows a changing state. After that then the air spool 11 will change state from closed to open toward the air orifice 21 as FIG. 3 shows an unused state. Since the ink spool 4 is closed, It blocks ink reservoir 9 to flow to the pen tip 1 by gravity.

If temperature or barometric pressure changed in unused state, The pressure of ink reservoir is balanced by the opening of the air orifice 21 through the air outlet 12. If reverse pen body in unused state, the ink spool 4 sealed will create a vacuum to hold reservoir ink out from the air orifice 21.

If temperature or barometric pressure changed during writing state, cause the vacuum become a pressure in ink reservoir 9 and push bottom ink out. It will pass through the ink spool 4 and the ink orifice 14 and deposit at valve rod hollow duct 7, because the pen tip 1 is much difficult to go through compare to an empty duct. But rising the ink level at hollow duct 7 higher and higher will cause a higher constant pressure to pen tip all the time. Since pen tip is writing and consuming the ink, it won't feel dripping at the pen tip. But later in unused state, the pen tip will drip ink at long hours because of high-level ink gravity constant press on tip. Since a retractable ink pen not reverse it pen body and keep pen tip retract all the time except during writing, there will not have a chance to create much deposit ink in hollow duct 7. Because the room temperature or the barometric pressure stays the same condition during normal writing period.

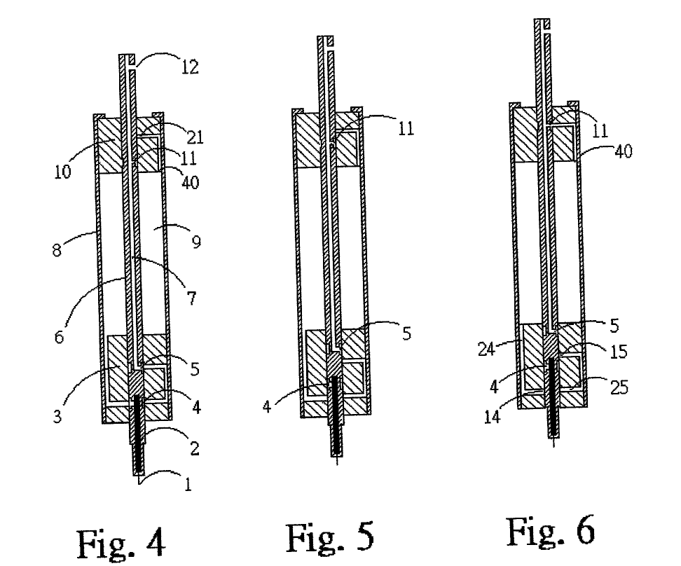

In order to improve unused state with high-level ink gravity in hollow duct 7 which causing pen tip dripping after long hours, a vent valve is added at top of ink valve and in serial connection. The vent valve consists of a vent spool 5 on the valve rod 6 and a vent orifice 15 and a vent duct 25 on the pen tip valve body 3 as FIG. 6 shows. The pen tip valve now contains the vent valve at top and the ink valve at bottom and the vent duct 25 connects to the vent orifice 15 to ink orifice 14 as FIG. 4 shows. Refer to FIG. 4, when at writing state the ink spool 4 provides connection among ink reservoir 9, the pen tip 1 and the vent duct 25 and the vent spool 5 directs air from the air outlet 12 to the vent duct 25. The vent duct 25 also may connect the vent orifice 15 to ink reservoir 9 directly without going through the ink orifice 14 as part of FIG. 9 shows. Since the vent valve function is to direct air through inside of the valve rod 6, the vent valve and hollow duct 7 in the valve rod 6 can be combined as a separate duct 28 which at out side of the valve rod 6 to perform the same function. And its reservoir air can vent from a different outlet 29 on the air valve body 10 if the duct 28 not direct back to the valve rod 6 at inside of the air valve body 10 as FIG. 7 shows.

Refer to FIG. 4, this 2 valves inside of the pen tip valve type cartridge in writing state, the absorbing material 2 draw ink from the ink orifice 14, since air spool 11 is sealed, a vacuum is created in ink reservoir 9. When this vacuum is strong enough, the air will pass the air outlet 12 to the vent spool 5, the vent orifice 15, the vent duct 25, the ink orifice 14, the ink duct 24 to balance reservoir vacuum. Due to ink gravity in absorbing material 2 and capillary action when the pen tip 1 touches a paper cause to generate a force to keep drawing ink to the paper during continue writing. During changing state, the ink spool 4, the vent spool 5, and the air spool 11 all are closed as FIG. 5 shows. When unused state, the air spool 11 is opened to balance ink reservoir 9, the ink spool 4 is closed to stop reservoir to pen tip, the vent spool 5 is closed to prevent any ink deposit in hollow duct 7 back to the pen tip 1. The pen tip will not dripping ink because it been complete sealed at unused state even a high ink level in hollow duct 7 was created by unexpected condition in writing state or at reverse pen body condition.

When reservoir ink getting less and less and the air getting more and more, the power of vacuum holding the ink in ink reservoir 9 will getting more and more hesitation. This will cause ink flows more to tip than in less air in reservoir condition. To improve this situation, two-chamber type can be used. As part of FIG. 9 shows, add a vacuum valve 32 to separate original reservoir to an ink reservoir 9 and a vacuum chamber 33. The part of FIG. 8 also shows an end cap 34 with labyrinth grooves at top of cartridge tube to prevent unexpected spilling condition. The vent 40 on the end cap 34 to balance the reservoir air. Because vacuum chamber is a very small space, before its power of vacuum holding the ink getting hesitation, the ink reservoir 9 has been finished. This two-chamber type works as same as one chamber before. When writing, The vacuum valve 32 closed to create a vacuum in vacuum chamber 33 to hold ink, and the ink spool 4 opened and connects the vacuum chamber 33 to the pen tip 1. And the air outlet 12 to vacuum chamber 9 if a vent valve is used. When unused state, the ink spool 4 is closed to shut reservoir ink to the pen tip 1. And the vent spool 5 is closed if with a vent valve type. The vacuum valve 32 been opened balance the vacuum chamber 33 pressure and let reservoir ink to refill vacuum chamber 33 for next usage as part of FIG. 9 shows.

If pen body been reverse on writing state, reservoir ink is been keep by the air valve which is closed Because the gravity of ink deposit in the hollow duct 7 is not enough to overcome the sealing force generated by the ballpoint pen tip and the absorbing material, and will stay same position. If is a marker pen tip, or any other type which pen tip seal is not very well to hold duct ink in stay position, a tiny labyrinth groove bar 31 or a steal ball check 30 in the hollow duct 7 can be used.

It is very rare case that a tip retractable pen writes during severe temperature rising condition or dramatic barometric pressure difference situation. To improve unwittingly action as above or a pen tip can not hold the ink when gravity in the hollow duct 7 accumulate at higher level, a tiny labyrinth groove bar 31 inside of the hollow duct 7 can be used as FIG. 10 shows. At above situation, the ink in duct 7 will rise to a higher level. The gravity will increase cause extra pressure to pen tip. Since it is in writing, ink consuming is offset the condition. Depend on pen tip type, ink may leaks from pen tip when not consuming ink at long run in writing state. The labyrinth groove bar 31 is a long bar with lots of tiny disks in parallel which forms lots of tiny gaps. There is a split on each disk to make ink or air pass through freely. The ink between each disk gap creates capillary action to hold ink weight. So ink flows in the hollow duct 7 do not depend on gravity but depend on capillary action when tip touching to the paper. So if not writing, ink will not drip out from pen tip.

Normally it is very rare case that a tip retractable pen will reverse its pen body in following condition: drop pen to ground, temperature rising very much or barometric pressure fluctuation a lot. To improve unwittingly condition as above, a steal ball check 30 can prevent ink leaking out from the air outlet 12 as FIG. 11 shows. The steal ball check 30 locates near and below the air outlet 12. And its stroke is very short. As soon as reverse pen body, ball weight will seal the path immediately and stop hollow duct flow till pen body back to normal condition and steal ball fall back to open by it own weight.

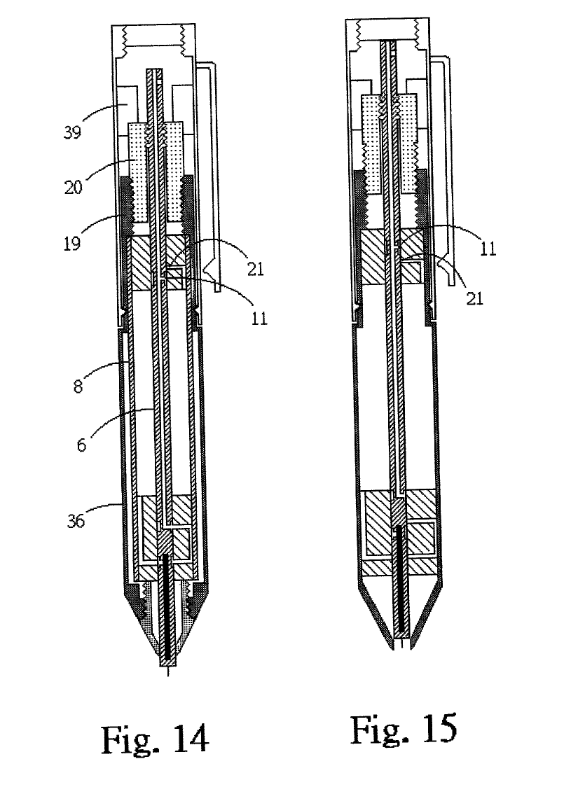

It may seal air spool 11 both in writing and unused state as parts of FIG. 14 and FIG. 15 shows. This air spool 11 opens only during changing state while the ink spool 4 has closed and seals all outlets to ensure all kind of unexpected conditions in unused state. But this needs to move valve rod slow during changing state to ensure finishing balance pressure before reaching to writing state.

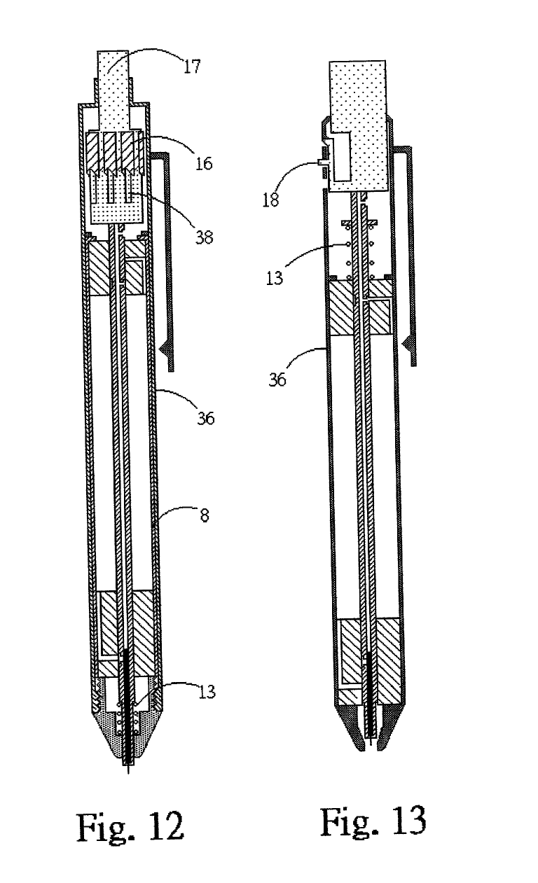

This application applies the pen body 36 in a mechanical ball pen. Refer FIG. 12, When push slide 17, the sliding carousel 38 moves the valve rod 6 down and change valves to writing state. After the sliding carousel 38 reaches locking position and sit on the stationary carousel 16, pen tip still stays out while all valve set on writing state for writing as FIG. 12 shows. If retract, push again to release mechanical mechanism. The valve rod is retracted by a spring 13 till reaches to final stop, and all valves will be reset back as unused state as part of FIG. 13 shows.

FIG. 13 shows the directly apply inside of a pen body 36 in a notch locking pen type. When push top knob of the notch lock 18, the valve rod move down to change valves state to writing state, and at notch lock 18 in locking position the pen tip will show up for writing. When retract, release the notch lock 18, a spring 13 retracts pen tip and reset valve rod back to unused state as part of FIG. 12 shows. This direct apply to pen body is same in a mechanical ball pen type pen body.

FIG. 14 shows the ink cartridge applies in a twist type pen body 36. The whole ink cartridge with all valve bodies will stay still with pen body's lower twist part all the time. The moving spline 20 contains valve rod 6 by thread as one piece. When twisting pen body's lower twist part, thread 19 turns the moving spline 20. Because the fix spline 39 stops the moving spline 20 from turning, the moving spline 20 moves down straight instead and moves valve rod down to change valves to writing state. At end of twist action, pen tip show up for writing as FIG. 14 shows. Reverse twist direction on pen body's lower twist part, the moving spline 20 containing valve rod will move up to retract pen tip. At end of twist action, all valves will be changed to unused state as part of FIG. 15 shows. The FIG. 15 also indicates this invention directly apply inside of a pen body 36.

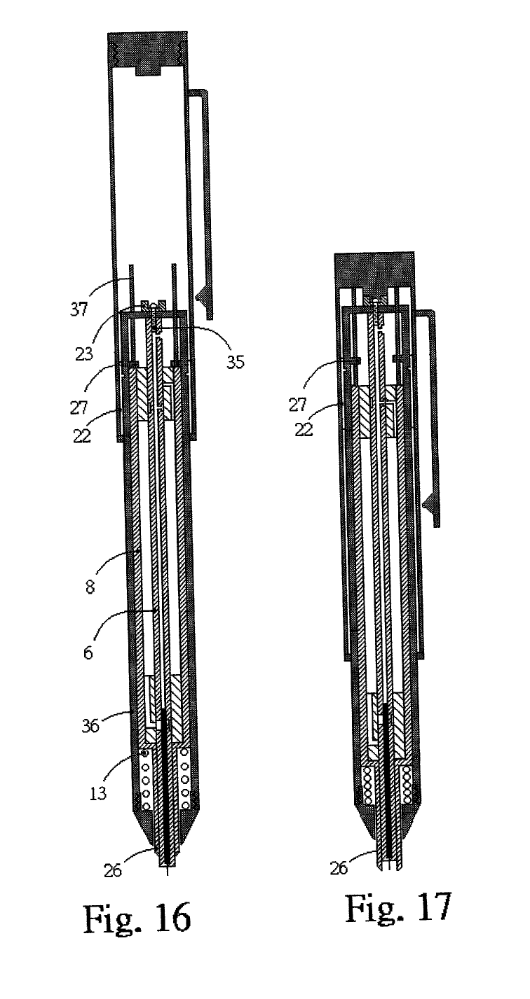

Refer to FIG. 16, this application applies the pen type body 36 in a telescopic pen. The tip protection slide 26 is part of the ink cartridge tube s8. To shorten, push the upper part pen body and slides by the guide 22 into lower part pen body. Near the end of stroke, it push a connecting rod 37 and overcome the spring 13 to force the cartridge tube 8 with all valve body moved to change state and the tip protection slide 26 comes out to protect the pen tip 1. The valve rod 6 stays same position because it is been fixed by a screw 35 on pen body lower part. At end of stroke, the magnetic 23 secure locking position and valves change to unused state as FIG. 17 shows. When writing, pull upper part of pen body to break magnetic force. The guide 22 finally will stop upper pen body. The spring 13 will force the cartridge tube 8 with all valve body to retract to a stop 27 and let the pen tip 1 shows up for writing. Since the valve rod 6 is fixed on lower part pen body by a screw 35, and will stay still while the cartridge tube 8 with all valve body to retract by the spring 13. And change all valves to writing stage as FIG. 16 shows.

Drawing number list:

| | | | |
|---|---|---|---|
| 1. Pen tip | 2. Absorbing material | 3. Pen tip valve body | 4. Ink spool |
| 5. Vent spool | 6. Valve Rod | 7. Hollow duct | 8. Cartridge tube |
| 9. Ink reservoir | 10. Air valve body | 11. Air spool | 12. Air outlet |
| 13. Spring | 14. Ink orifice | 15. Vent orifice | 16. Stationary carousel |
| 17. Slide | 18. Notch lock | 19. Thread | 20. Moving spline |
| 21. Air orifice | 22. Guide | 23. Magnetic | 24. Ink duct |
| 25. Vent duct | 26. Tip protection slide | 27. Stop | 28. Duct |
| 29. Outlet | 30. Ball check | 31. Labyrinth groove bar | 32. Vacuum valve |
| 33. Vacuum chamber | 34. End cap | 35. Screw | 36. Pen body |
| 37. Connection rod | 38. Sliding carousel | 39. Fix spline | 40. Vent |

What I claim as my invention are:

1. A liquid ink type retractable pen which has no cap to protect its pen tip, instead its pen tip or its pen tip protection cover is retractable and applies in watery liquid ink, including: a tip retractable pen body and a liquid ink cartridge at inside of the pen body, characterize by the liquid ink cartridge comprising:
a cartridge tube 8;
locating at top of the inner cartridge tub, an air valve body 10 contains a reservoir vent 40;
locating at bottom of the inner cartridge tub, a pen tip valve body 3 includes an ink duct 24, an ink orifice 14;
locating at inside of the cartridge tub, a valve rod 6 connects through above 2 valves body, and the valve rod outside contains an air spool 11 for the air valve's spool, an ink spool 4 to match the ink orifice 14 and bottom of the valve rod 6 is a pen tip 1, inside of the valve rod 6 has a hollow duct 7 that has a path to: an air outlet 12 at top end, the air spool 11 and passing the absorbing material 2 to the ink spool 4.
the liquid ink in ink reservoir 9 which inside the cartridge tube 8 between the air valve body 10 and the pen tip valve body 3 excludes the valve rod 6;
the above ink retractable pen by the valve rod 6 changes valves open-closed and pen tip's in-out for writing or unused

2. A liquid ink type retractable ball pen as claimed in claim 1, wherein the cartridge tube 8 is omitted and is replaced by its pen body 36 inner wall.

3. A liquid ink type retractable ball pen as claimed in claim 1, wherein the hollow duct 7 of the valve rod 6 contains a steal ball check 30 below the air outlet 12.

4. A liquid ink type retractable ball pen as claimed in claim 1, wherein the hollow duct 7 of the valve rod 6 contains a labyrinth groove bar 31.

5. A liquid ink type retractable ball pen as claimed in claim 1, wherein the ink reservoir 9 is separated by a vacuum valve 32 and becomes two chambers: a reservoir chamber 9 at top side and a vacuum chamber 33 at bottom side.

6. A liquid ink type retractable pen which has no cap to protect its pen tip, instead its pen tip or its pen tip protection cover is retractable and applies in watery liquid ink, including: a tip retractable pen body and a liquid ink cartridge at inside of the pen body, characterize by the liquid ink cartridge comprising:
a cartridge tube 8;
locating at top of the inner cartridge tub, an air valve body 10 contains a reservoir vent 40;
locating at bottom of the inner cartridge tub, a pen tip valve body 3 includes an ink duct 24, an ink orifice 14, a vent duct 25 and a vent orifice 15;
locating at inside of the cartridge tub, a valve rod 6 connects through above 2 valves body, and the valve rod outside contains an air spool 11 for the air valve's spool, a vent spool 5 to match the vent orifice 15, an ink spool 4 to match the ink orifice 14 and bottom of the valve rod 6 is a pen tip 1, inside of the valve rod 6 is a hollow duct 7 which has a path to: an air outlet 12 at top end, the air spool 11 and the vent spool 5, then a separated duct containing absorbing material 2 with an opening on the ink spool 4;
the liquid ink in ink reservoir 9 which inside the cartridge tube 8 between the air valve body 10 and the pen tip valve body 3 excludes the valve rod 6;
the above ink retractable pen by the valve rod 6 changes valves open-closed and pen tip's in-out for writing or unused.

7. A liquid ink type retractable ball pen as claimed in claim 6, wherein the cartridge tube 8 is omitted and is replaced by its pen body 36 inner wall.

8. A liquid ink type retractable ball pen as claimed in claim 6, wherein the vent orifice 15 in the pen tip valves body 3 and the vent spool 5 on the valve rod 6 are replaced by a separate duct 28 that at outside of the valve rod 6.

9. A liquid ink type retractable ball pen as claimed in claim 6, wherein the hollow duct 7 of the valve rod contains a steal ball check 30 below the air outlet 12.

10. A liquid ink type retractable ball pen as claimed in claim 6, wherein the hollow duct 7 of the valve rod contains a labyrinth groove bar 31.

11. A liquid ink type retractable ball pen as claimed in claim 6, wherein the ink reservoir 9 is separated by a vacuum valve 32 and becomes two chambers: a reservoir chamber 9 at top and a vacuum chamber 33 at bottom.
